(19) United States
(12) Patent Application Publication
(10) Pub. No.: US 2002/0065100 A1
(43) Pub. Date: May 30, 2002

(54) Cellular receiver with location processor

(75) Inventors: Joseph Nir, Rehovot (IL); Baruch Shayevits, Rishon Lezion (IL); Hanoch Cohen, Rishon Lezion (IL)

Correspondence Address: DR MARK FRIEDMAN LTD, c/o Bill Polkinghorn - Discovery Dispatch, 9003 Florin Way, Upper Marlboro, MD, 20772, US

(73) Assignee: CELLGUIDE LTD.

(21) Appl. No.: 09/726,049

(22) Filed: Nov. 30, 2000

(51) Int. Cl. H04B 1/38

(52) U.S. Cl. 455/553; 455/550; 455/456

(57) ABSTRACT

In a cellular receiver, RF signals of a network are received and front-end processed for extracting baseband signal. A telephony processor (216) consequently extracts telephony signals. When no incoming or outgoing telephony signals are detected, a location processor (220) is set for signal receive, and default settings of a frequency synthesizer (224) of the downconverter is changed. In one embodiment, if no location signal is received, a “power down” routine is implemented.

### FIELD OF THE INVENTION

The present invention is generally in the field of dual-purpose mobile receivers of cellular networks. More specifically, the invention relates to receivers having facilities for both telephony and navigation services.

### BACKGROUND OF THE INVENTION

Cellular networks provide navigation services for mobile stations afforded by positioning data propagated by base stations. Thus, signal propagated in a base station is received in a mobile station, and the time it takes for the signal to reach the mobile is calculated. An assumption regarding the displacement of the mobile receiver from the transmitting base station can then be made. Measuring displacements with respect to several known base stations provides sufficient data for locating the mobile receiver geographically, since the geographic positioning of the base station is known.

Cellular networking standards usually extend provisions for reduced power consumption as a measure for upgrading the energy budget of mobile systems. A “power down” mode of a receiver is a low power consumption mode effected when the receiver does not communicate with the network. A “power down” routine includes however a periodical check of the net in order to intercept incoming calls. In these periodical checks the power goes up, as well as upon initiation of an outgoing message.

In dual purpose receivers, such as operating both as telephony transceivers and mobile location terminals, the implementation of power conserving architecture of the receiver becomes an advantage. Sharing circuit components by more than one application is one application which has been demonstrated.

### SUMMARY OF THE INVENTION

The present invention provides a receiver for a wireless network, which processes incoming RF signals and extracts baseband signal. By default, a telephony processor consequently processes telephony signals. When no incoming or outgoing telephony signals are detected or scheduled, a location processor is set for signal receive. If no location signal is received or scheduled, a “power down” routine is implemented, which includes periodical check of incoming telephony RF signals.

According to another embodiment of the present invention, the signal is redirected to the location processor, initiated through the utilization of a “power down” routine.

### BRIEF DESCRIPTION OF THE DRAWINGS

FIG. 1A is a block diagram, showing the control connections of the location processor over frequency downconversion, in an embodiment of the invention.

FIG. 1B is a block diagram, showing the downconversion control by a location processor in an embodiment of the invention.

FIG. 1C is a block diagram, showing the control connections of a location processor including power down control, in an embodiment of the invention.

FIG. 2 is a flowchart illustrating the sequence of events in a cellular receiver, using power down routine for shifting states from telephony to location processing.

FIG. 3 is a flowchart illustrating the sequence of events in a cellular receiver, shifting states from telephony to location processing.

### DETAILED DESCRIPTION OF THE PRESENT INVENTION

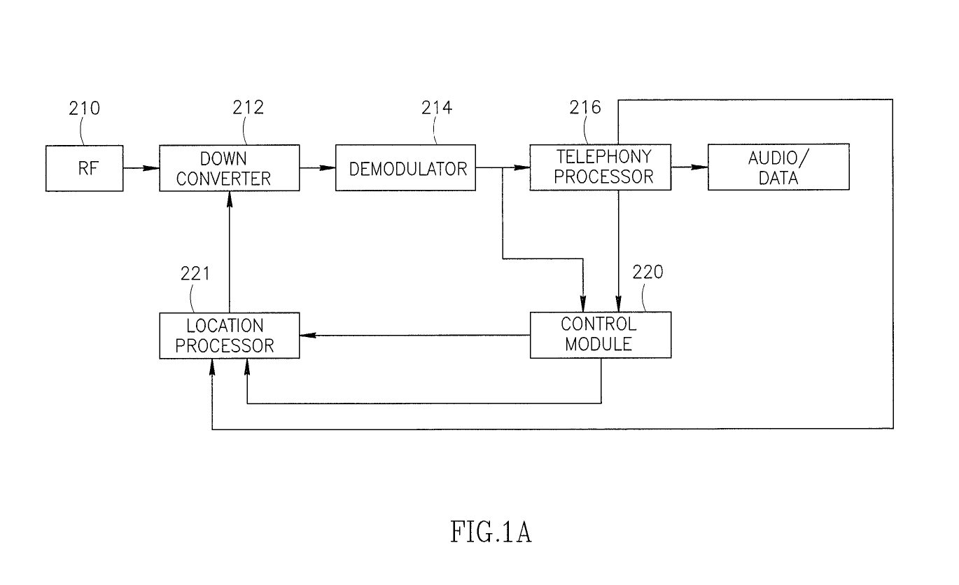

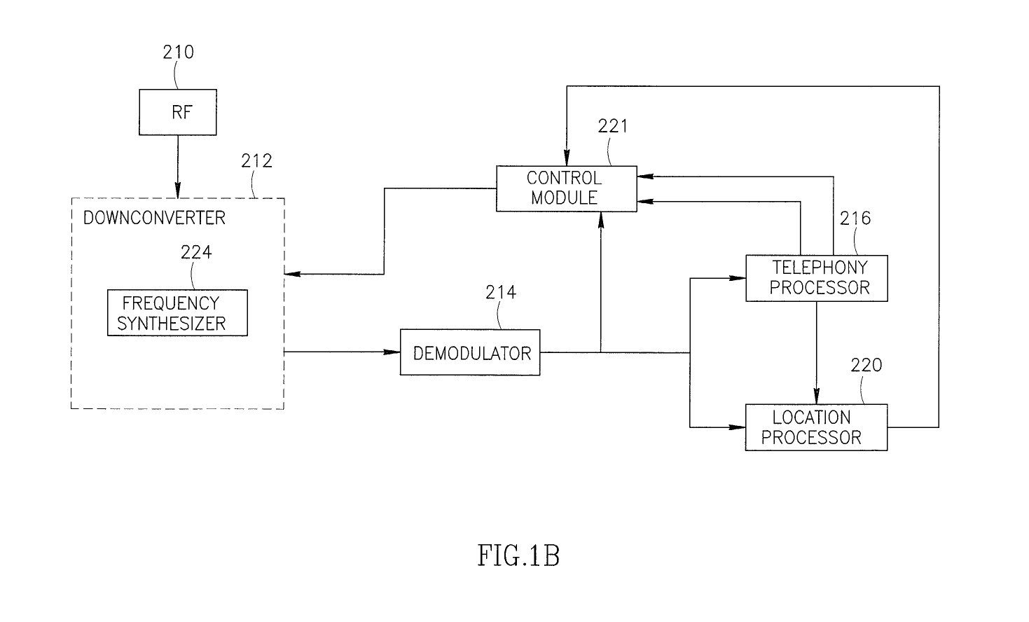

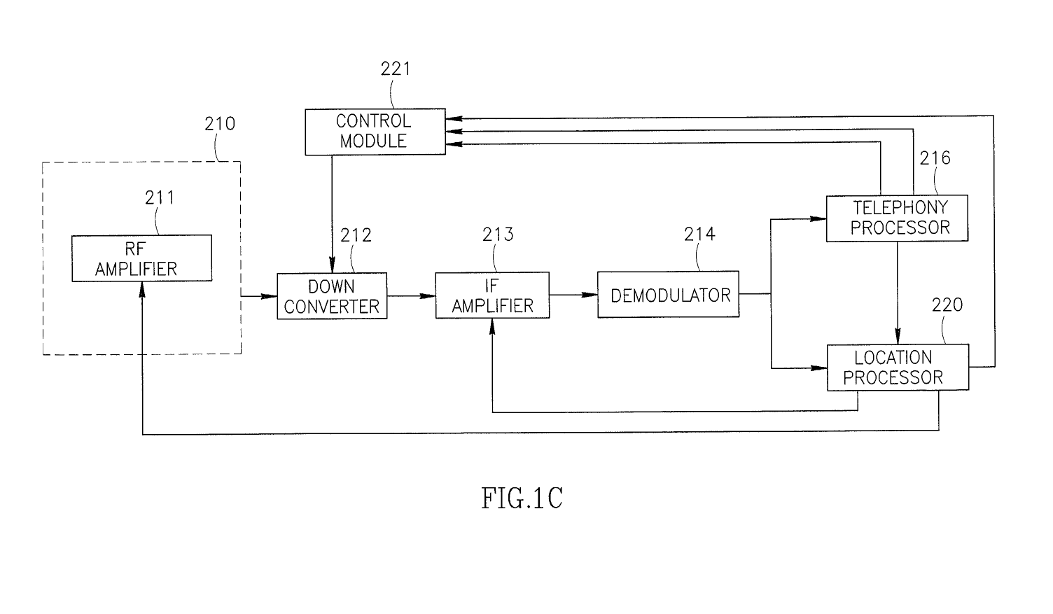

A mobile receiver can collect signals from several base stations concomitantly and use some of the information for telephony communications and some of the information for location purposes. In the present invention, circuitry is provided for efficiently controlling the allocation of resources of a dual-purpose receiver. Reference is now made to FIG. 1A which is a block diagram describing the main building blocks and the interconnections between them in a receiver according to a preferred embodiment of the present invention, in which telephony and location applications circuitry cohabitate. RF circuitry 210 provides amplified and filtered signal to downconverter 212, which produces low frequency signal, typically IF, containing the relevant data carried by the RF carrier of the cellular network. Demodulator 214 provides the baseband originally modulated on the RF signal, which is then sent to telephony processor 216. There, telephony audio/data is extracted from the baseband. However, on occasions as defined by the telephony processor and described in detail later on, telephony processor 216 redirects the baseband signal to location processor 220, so that baseband signal goes directly, or indirectly through processor 216, to location processor 220. In doing so, the location processor 220, which according to this embodiment has a control channel to the control module 221, changes default parameters in the downconverter 212, bringing it to a locate mode. This is achieved by the location processor 220 taking over the control module 221, as a result of which another RF band is downconverted to produce typically the same IF frequency as the other RF band. This will be explained in the following frequency relations:

RF₁−F_{1(downconverter)}=IF₁

and

RF₂−F_{2(downconverter)}=IF₁

In other words, in order to obtain common IF frequency from different RFs, it is necessary to change the reference frequency of the downconverter. It will be appreciated that the location processor and telephony processor can effectively be implemented in software on the same IC (integrated circuit) chip.

FIG. 1B to which reference is now made, describes in more detail the circuitry aspects and consequences of the redirection of baseband from telephony processor 216 to location processor 220. Consequent to baseband signal being redirected directly or indirectly through processor 216, to location processor 220, control module 221 receives control message through the control channel from the location processor, which causes a subsequent shift from the default parameters of frequency synthesizer 224. As a consequence of this shift in the mode of the frequency synthesizer, the downconverter 212 shifts the downconversion frequency it applies on the RF frequency coming from the RF circuit 210. At the same time, control module 221 changes additional default parameters of the downconverter 212, typically those of the gain. Demodulator 214 demodulates the input frequency, extracting baseband, which is directed to location processor 220.

FIG. 1C to which reference is now made, describes another preferred embodiment of the invention in which the location processor not only takes over RF signals, but the downconversion parameters are changes as well as other aspects of the receiver. Upon cessation of telephony processing by processor 216, and if no telephony signals scheduled to be received or sent, the baseband signal is redirected to the location processor 220 which accepts the baseband signal through either processor 216 or directly from demodulator 214. In another approach to the relationship between the processors, the two processors are implemented in software in the same DSP (digital signal processor) chip and the redirection procedure is implemented in software. Location processor 220 then initiates a “power-down” routine, which decreases considerably the power consumption of amplifier 211 of the RF circuit and amplifier 213 of the IF circuit as well as other power consuming components. Concomitantly, control module 221 changes default parameters of downconverter 212 such that frequency and gain parameters are changed. Upon user's demand, or based on predefined schedule, the power-down command is reversed and the amplifiers turn to power up mode thus facilitating a location schedule to take place, as a result of which location processor 220 extracts location data from the incoming baseband.

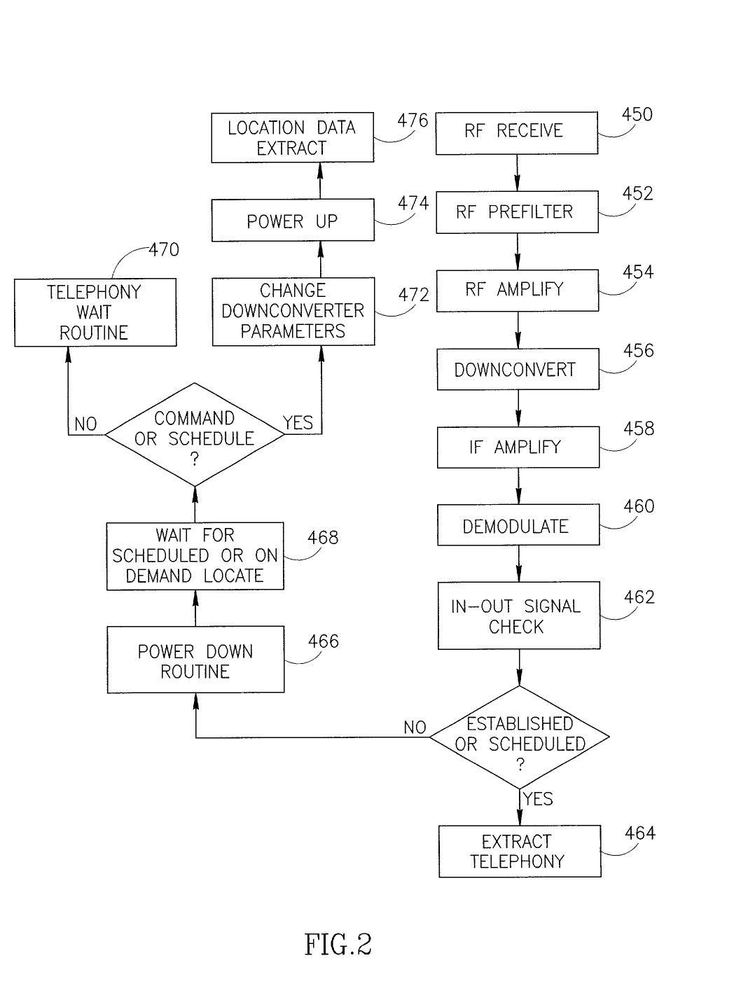

FIG. 2 to which reference is now made is a flow chart of a comprehensive system describing the sequence of steps performed according to the present invention. In step 450 the RF signal is received, and in step 452 the RF received is prefiltered to rid of energy outside of the prescribed range of the cellular network. In step 454 the filtered RF signal is amplified and in step 456 it is downconverted by a the downconverter in state A to IF, for later processing. In step 458 the IF signal is amplified and demodulated in step 460. The signal is processed in the telephony processor which checks for outgoing signal as well for incoming signal in step 462. If incoming signal is received, telephony is extracted in step 464. If no signal is received or sent or no scheduled outgoing-incoming signal is expected, the system enters into power-down mode for saving power, in step 466. Then, the location processor enters a wait state in step 468. If no location command is effected, either on demand or by schedule, the system goes into a wait routine in step 470, in which the downconverter is reset to telephony frequency, and the power goes up periodically to receive possible incoming telephony signals. If a location command is effected, the downconverter parameters are changed at step 472, which includes typically a change in frequency and in the gain parameters. Then power goes up in stage 474, and location data extracted in step 476.

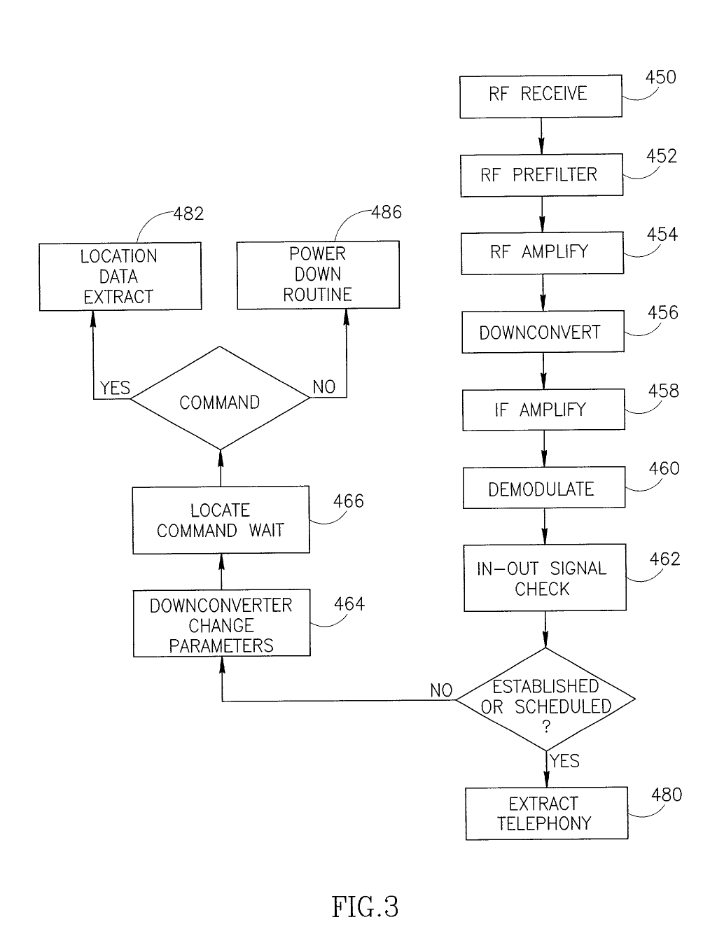

An alternative embodiment is illustrated in the flow chart of FIG. 3 to which reference is now made. RF is received in step 450, RF is prefiltered in step 452, and RF amplified in step 454. Downconversion is effected in step 456 and IF is amplified in step 458. Demodulation is effected in step 460 to provide the baseband for further processing of the transmitted information. In step 462, established incoming and outgoing signals are verified, as well as scheduled signals. In case telephony signals occur or are scheduled to occur, the telephony processor is set for telephony extraction in step 480. If telephony signals do not occur or are not scheduled to take place, parameters of downconverter are changed in step 464, typically those affecting frequency and gain. In the next step, 466, the location processor waits for an on-demand or scheduled locate command. If such a command is not made or is not scheduled, location data is extracted in stage 482. If a locate command or a locate schedule do not occur, a “power-down” routine is implemented in step 486. This “power down” routine includes resetting downconverter to accept telephony frequency and periodically checking for incoming telephony calls.

1. A dual purpose receiver for cellular networks in which RF signals are front-end processed, amplified, downconverted to lower frequency signals, demodulated and telephony signal thereof processed by a telephony processor, comprising:
a location processor for extracting location data from said lower frequency signals,
a control module for changing working parameters of at least a frequency synthesizer of said downconverter from default to location data extract, and
amplifiers for RF signal and for lower frequency signal.

2. A dual purpose receiver for cellular networks as in claim 1 and wherein at least said amplifiers for RF and for lower frequency respectively each have a power down mode of action, the entry to which is controlled by one of said processors.

3. A dual purpose receiver for cellular networks as in claim 1 and wherein gain parameters of said downconverter are changed by said control module.

4. A method for implementing both telephony and location services in a mobile receiver of a cellular network, wherein received cellular RF signals are filtered, amplified and downconverted, producing lower frequency signals and respective basebands thereof extracted, to be subsequently processed in at least one processor, comprising:
redirecting said lower frequency signals to a location processor when no telephony signals are received and are not expected to be sent or received,
changing parameters of said downconversion for producing baseband of a location signal,
extracting location data in said at least one processor,
resetting said parameters of said downconversion when location is not required for location.

5. A method for implementing both telephony and location services in a mobile receiver of a cellular network, implementing a power down routine whenever no incoming and outgoing telephony signals are processed and none are scheduled to be processed.

6. A method for implementing both telephony and location services in a mobile receiver as in claim 4, and wherein a telephony processor initiates said power down routine.
